(19) United States
(12) Patent Application Publication
(10) Pub. No.: US 2013/0112623 A1
(43) Pub. Date: May 9, 2013

(54) COMPOSITE MATERIAL

(71) Applicants: MARCELLO FERNANDEZ-LAHORE, Bremen (DE); MARIANO GRASSELLI, Buenos Aires (AR)

(72) Inventors: MARCELLO FERNANDEZ-LAHORE, Bremen (DE); MARIANO GRASSELLI, Buenos Aires (AR)

(73) Assignee: JACOBS UNIVERSITY BREMEN GGMBH, Bremen (DE)

(21) Appl. No.: 13/681,427

(22) Filed: Nov. 20, 2012

Related U.S. Application Data
(63) Continuation of application No. 12/449,956, filed on Oct. 15, 2009.

(30) Foreign Application Priority Data
Mar. 7, 2007 (EP) 07004710.5

(51) Int. Cl. B01D 15/20

(52) U.S. Cl. CPC B01D 15/20
USPC 210/656; 527/314; 522/89; 428/401; 525/54.1; 525/451; 210/198.2

(57) ABSTRACT

The invention describes a composite microfiber, which is comprising a polysaccharide polymer selected from the group consisting of cellulose, hydroxyethyl cellulose, hydroxypropyl cellulose, methyl cellulose, ethyl cellulose, n-propyl cellulose, isopropyl cellulose, cellulose acetate and combinations of two or more of these substances, and combinations of two or more of these substances, thereby the polysaccharide polymer further comprising substituents comprising a given formula, wherein k is 1 or greater, and wherein each moiety R₁ is independently selected from H and methyl, and wherein each moiety R₂ is independently selected from —H, —OH, —NH₂, —SH, —OR₃, —NHR₃ and —NR₃R₄, —SR₃, and wherein each moiety R₃ and R₄ are chemical groups independently selected from C1-C4 alkyl, C1-C4 alkoxy, C1-C4 alkoxy halide and C1-C4 heteroalkyl substituents, and is preferably selected from —CH₃, —CH₂—CH₃, —CH₂—OH, —CH₂—CH₂—OH, —CH₂—CH₂—NH₂, —CH—CH(OH)—CH₂—OH, —CH—CH(OH)—CH₃, glycidyl, anhydride, sulfonic acid and hydroxysuccinimide, said substituents forming a hydrogel in the presence of water, and said composite microfiber having a swelling factor of at least 10%, preferably of 10-400%.

### CROSS REFERENCE TO PRIOR APPLICATIONS

This application is a continuation of application Ser. No. 12/449,956, filed on Oct. 15, 2009, which is a U.S. National Phase application under 35 U.S.C. §371 of International Application No. PCT/EP2008/001828, filed on Mar. 7, 2008 and which claims benefit to European Patent Application No. 07004710.5, filed on Mar. 7, 2007. The International Application was published in English on Sep. 12, 2008 as WO 2008/107196 A2.

### FIELD

The present invention relates to composite microfibrous materials, particularly for chromatography, and their production and uses.

### BACKGROUND

Chromatographic methods include several separations modes like size exclusion chromatography, ion exchange chromatography, hydrophobic interaction chromatography, reverse phase chromatography, affinity chromatography, immunoadsorption chromatography, and other well-known chromatographic techniques. Presently, chromatographic-adsorptive separations utilizing beaded supports, monoliths or membrane media are used for purification and recovery of proteins and biological macromolecules. By use of beads, monoliths and membranes, separations are accomplished through similar physicochemical interactions but in hydrodynamically different ways. A major difference between these three chromatographic media is the accessibility of the superficial fluid flow to the adsorbing surface where reactive sites are present.

Bead-based media have convective flow occurring at the bead surface while most of the adsorbing surface is internal to the bead and can only be reached via diffusion—a slow process, especially in the case of macromolecules such as proteins. The convective fluid flow properties are determined by the bead size. Since most of the binding sites on the beaded support are accessed through diffusion of the targeted molecule, the dynamic binding capacity i.e. the capacity in a flow-through mode at a given flow rate, is coupled to the bead size and therefore to the convective flow properties of the adsorbent. Smaller beads, however, require a higher pressure to attain an equivalent flow rate than larger beads when packed into a column. It is current practice to pack such beads into a chromatography column forming a bed of media through which a fluid containing the material to be captured is passed. After washing to remove unbound contaminants, the captured material is eluted from the beads and collected.

Several drawbacks exist with bead-type media: The packing of the beads into a column is a difficult and laborious task. One needs to be sure that the column is properly packed so as to avoid channeling, bypass and blockages within the column. Further, the use of beads limits the depth of the media in process applications because of the pressure that must be overcome. Excess pressure may compress the beads. Softer beads tend to compress more than rigid beads. Compression is indicated by a steep increase in pressure drop across the bed at sufficiently high flow rates. High pressure drop is cause by compression of the beads and subsequent reduction of void volume at the column exit. Pressure drop is especially important in soft gel bead systems, where slow flow rates are mandatory to ensure acceptable performance.

As chromatography beads are porous and the selected entities to be captured must diffuse into the pores of the media to get captured, the speed and capacity of the whole system is diffusionally limited. There are two main diffusional bathers: one surrounding the bead where a film of liquid may form and reduce the movement of the selected molecule from the liquid bulk to the bead surface, and a second internal or particle-side diffusional resistance which is determined by the size, number and length of the pores formed within the bead support. As a result, traditional chromatography has worked based on a compromise between resolution and capacity. This compromise is required mainly by differences between the velocity of diffusional mass transport inside the particles and convective flow on the surface. Additionally, the permeability of the media is related to bead size as well as the media stability. Larger beads and beads with larger pores tend to have higher permeability. Beads that are not subject to or less subject to compression also tend to have greater permeability. However, at high flow rates, the dynamic capacity for target macromolecules decreases. Dynamic capacity refers to the fraction of the total equilibrium capacity which is actually utilized under process conditions i.e. when residence time is limited. On the other hand, permeability can decrease upon deposition of biological particles which might be present in a non-perfectly clarified feedstock.

Moreover, and since the mentioned soft beaded adsorbents are utilized in packed-beds, intensive clarification of the feedstock should be performed to avoid column blocking and backpressure development. Crude fermentation broths contains biological particles like cells or cell debris which can form very compressible filtration cakes and which can be adherent towards process surfaces. Therefore, extensive solids removal e.g. by filtration or centrifugation is typically performed in advance to any chromatographic step.

An important challenge has been finding the best way to expose quickly and efficiently the mobile phase and the sample molecules to the entire surface area of the chromatographic material, including the area inside the pores. For this alternative membrane or monolithic adsorbers have been proposed. These systems offer much less resistance to mass transfer and therefore they allow breaking the relationship between flow rate and resolution, working at high flow rates and high resolution. They are typically 10 to 100 times faster than conventional chromatography.

Membrane adsorption utilizes microfiltration membranes where the surface has been functionalized to obtain a selective binding. Because the binding capacity is only a surface phenomenon in this design, as the pore size increases the binding capacity decreases. Equilibrium or static capacity refers here to the quantity of the target molecule that is bound or adsorbed per mass of adsorbent at longer contact times when the thermodynamic equilibrium is reached. However, one advantage of this surface-dominated binding is that there is no mass transfer resistance provided by the structure of the media to absorption. Additionally, membrane adsorption can alleviate from high system operating pressures. Membrane adsorbents are now available commercially but they have found limited application due to the fact that surface area dictates the binding capacity and to the fact that there are limits to the binding capacity one can achieve for a given permeability due to the coupled flow and binding properties. Other drawbacks for membrane-based systems are the poor release of the captured species and the fouling effect by biomass components during real operating conditions.

Direct contact methods, as explained below, which are only partially compatible with the presence of biological particles in the feedstock are being now proposed for sequestration of the targeted species from the whole, or partially clarified or diluted, fermentation broth. These include a) finite bath contactors, b) fluidized and classified bed systems, and c) mixed-matrix modules. The central property of these systems from the point of view of bioproduct processing is the increased interparticle distance within the bed. This allows the introduction of particle-containing feedstock without the risk of bed blocking. However, direct contact methods are prone to the deleterious effects caused by biomass interactions with the beaded materials. Impaired system hydrodynamics and concomitant loss in adsorption performance has been reported. Moreover, mass transfer limitations remain the same as those described for packed-bed systems.

What is desired is an adsorptive or chromatographic media having increased system productivity, which binds reversibly the targeted species, and which is tolerant to biomass in order to allow direct processing of a crude feedstock.

Without relation to chromatography applications, a number of methods for modifying materials have been developed. Some of these methods are discussed hereinafter to elucidate the technical background of the invention and to provide hints enabling the skilled person to work the present invention, but without any explicit or implicit admission that any of these methods were or are relevant for assessing novelty and inventive step of the present invention.

Regarding to the base material or support, several methods for modifying textile fibers like cotton and other cellulosic materials—or various other natural, manmade, regenerated and synthetic fibers materials—have been developed since 1960. Most of them were studied by the textile industry to alter cloth or fabric properties in order to improve various performance properties such as water resistance, soil resistance, speed of drying, permanent press, and abrasion resistance properties.

Methods for modifying materials with reactive groups such as hydroxyls and amines have been developed in the art, however, materials with hydroxyl groups, including polysaccharides such as cellulose, have been found to be difficult to modify via covalent chemical bonds and therefore require reactive modifiers or extreme conditions. Methods of reacting with hydroxyls that have been developed in the chemistry field include the use of acid chlorides, anhydrides, succinimides, and carbonyldiimidazole. See, e.g., J. March, “Advanced Organic Chemistry-Reactions, Mechanisms and Structure,”, 3rd Ed., John Wiley and Sons, New York, 1985; and G. Hermanson, “Bioconjugate Techniques,” Academic Press, Inc., San Diego, 1996.

Most chemical research in the textile field was conducted in the 1950s, 60s, and 70s. This piece of work has been extensively reviewed. For example, see: Smith and Block, Textiles in Perspective, Prentice-Hall, Englewood Cliffs, N.J., 1982; Handbook of Fiber Science and Technology, Marcel Dekker, New York, N.Y., Vols. I-III, 1984; S. Adanur, Wellington Sears Handbook of Industrial Textiles, Technomic Publishing Company, Inc., Lancaster, Pa., 1995; and Philip E. Slade, Handbook of Fiber Finish Technology, Marcel Dekker, New York, 1998). A large majority of this published research was never commercialized due to inhibitory costs or the impracticality of integration into textile production processes.

Radiation-induced polymerization to graft synthetic monomers was also early studied by Garnett and others (Grafting, J. L Garnett, Radiat. Phys. Chem. 14 (1979) 79-99). UV and gamma rays are able to initiate polymerization of acrylates and related vinyl monomers with high yield. Gamma rays are a highly penetrating radiation source yielding an homogeneous modification grafting. Three different techniques are available using ionizing radiation: pre-irradiation; simultaneous and peroxidation.

Several methods concerning graft polymerization onto cotton and cellulosic materials using chemical initiation, ultraviolet light (UV), cold plasma, electron-beam and gamma rays have been described in the last years. All of them made use of the pre-irradiation and peroxidation techniques. In general, chemical methods utilize cerium salts which have low polymerization efficiency. UV and cold plasma methods yield mainly surface-modified materials due to their low penetration efficiency. Electron-beam is a highly energetic source delivering energy in a very short time and thus, increasing the unwanted degradation process of trunk polymers.

Princia et al. described the UV-initiated grafting polymerization of methacrylates onto cotton in order to reinforce these materials. The mechanical strength and/or wetting behaviour of cellulose based textiles have been improved. (Synthesis and mechanical characterisation of cellulose based textiles grafted with acrylic monomers E. Princia, S. Vicinia, E. Pedemontea, G. Gentile, Mariacristina Cocca and Ezio Martuscelli. European Polymer Journal 42 (2006), pp 51-60).

Albertia et al described the use of electron beam as activation method. Powdered samples of cotton, flax and viscose from textile fibers were subjected to electron beam irradiation (20-400 KGy). Further treatment with glycidyl methacrylate solution (GMA) grafts the samples. (Electron beam irradiated textile cellulose fibers. ESR studies and derivatisation with glycidyl methacrylate (GMA) A. Albertia, S. Bertinib, G. Gastaldic, N. Iannacconed, D. Macciantellia, G. Torrib and E. Vismara, European Polymer Journal 41 (2005), pp 1787-1797)

Recently, Reddy et al. described the preparation of a flame retardant cotton fabric. The authors grafted GMA on ordinary or untreated cotton fabric by γ-rays from ⁶⁰Co source. Epoxy groups present in GMA grafted cotton fabric was reacted with ethylene diamine and subsequently modified with phosphate. (Ionizing radiation graft polymerized and, P. R. S. Reddy, G. Agathian and Ashok Kumar, Radiation Physics and Chemistry, 72 (2005), pp 511-516)

Takács et al recently described a preirradiation method to graft acrylamide (AAm), acylic acid (Aac), 2-hydroxypropyl acrylate (HPA), 2-hydroxypropyl methacrylate (HPMA) and N,N′-methylene bisacrylamide (BAAm) to cotton-cellulose by γ-rays from ⁶⁰Co source. Pre-irradiation was performed in AIR at a total dose of 40 kGy and dose velocity of 15 kGy/h. The presence of air is here important to allow the formation of peroxide radicals onto the cellulose upon irradiation, which later on became reactive when temperature is increased to 40° C. Grafting improved the swelling of the samples showing saturation at about 270% at neutral pH (with Aac and BAAm). For AAm, HPA and HPMA at low grafting yield an increase in swelling was found and then the swelling decreased with increasing grafting yield. However, degree-of-polymerization values (DP) for cellulose drop sharply from 1700 to 500 after 10 kGy irradiation. Scanning electronic microscope pictures showed that the main modification occurred on, and limited to, the external surface of the fiber. (Modification of cotton-cellulose by preirradiation grafting, E. Takács, L. Wojnárovits, J. Borsa, J. Pappa, P. Hargittai and L. Korecz, Nuclear Instruments and Methods in Physics Research Section B: Beam Interactions with Materials and Atoms 236 (2005), p 259-265). No internal modification of the fiber walls which is important to archive a high chromatographic adsorbent is obtained by such a method.

Hirotsu et al considered grafting under a plasma atmosphere, a technique that is also based on a pre-irradiation method. Glycidyl methacrylate (GMA) was graft-polymerized to plasma treated fibers and β-cyclodextrin was chemically bound to the grafted surface. The β-cyclodextrin immobilized fibers adsorbed phenols effectively from an aqueous solution (Plasma graft polymerization of glycidyl methacrylate and cyclodextrin immobilization, Toshihiro Hirotsu, Thin Solid Films 506-507 (2006), pp 173-175). This technique allowed the convenient polymerization of monomers onto of a plasma pre-treated substrate under atmospheric conditions. However, the composite structure is limited to the external surface of the material. Therefore, Hirotsu et al have considered a grafting technique under a plasma atmosphere which has the advantage of generate peroxides in a softer condition than electron beam irradiation or γ-rays preirradiation in air atmosphere. However, reactive sites are only present on the polymer surface i.e. a fiber modification limited to its external surface is achieved.

A traditional and well known method to obtain grafting is based on purely chemical strategies utilizing various monomers, a crosslinking agent, and different concentrations of ceric ammonium nitrate as initiator in aqueous nitric acid solutions at room temperature (Graft copolymerization of acrylic acid onto cellulose: Effects of pretreatments and crosslinking agent. Gülten Gürdag, Gamze Güclu, Saadet Özgümus. Journal of Applied Polymer Science 80 (2001), pp 2267-2272). This method is laborious, time consuming, and requires successive chemical modification to produce an adequate modification of the substrate. Grafting percentage is lower than the one obtained with radiation-induced grafting. Grafting percent from 0.1 to 30% are reached. A pre-treatment of the fibers involved the well-known treatment with NaOH solutions in order to improve the hydrophilic character of the material (mercerization). Unfortunately, authors do not physically describe and/or characterize the composite material; however, they assessed that the pre-treatment of cellulose with NaOH solution did not increase the grafting percentage, in fact, decreased it. An also the equilibrium swelling capacity (the only material property measured) has not improved and it is in the range of 5 to 7%. From this assessment it is straightforward deduced that grafting polymer is unable to generate a hydrogel-like structure inside the cellulose fiber and the grafted polymer should be outside the cellulose fiber.

None of these methods, however, are appropriate to the production of chromatographic supports, since grafting is inhomogeneous, limited to the substrate external surface, swelling properties are difficult to control, ligand immobilisation is difficult due to steric hindrance, and the mechanical properties of the resulting composite are poor. Moreover, none of these methods are appropriate for the production of chromatographic supports, since there is a lack in internal hydrogel grafting. This fact reduces the swelling ability of the resulting composite and concomitantly the specific adsorption properties.

EP-A-1 514 597 disclose a method where polymer grafting is performed onto micro-porous synthetic membranes by electron beam irradiation. The successful implementation of such technique depends on more specific conditions, which are neither trivial nor obvious, like radiation type, irradiation strategy (simultaneous vs. pre-irradiation), environmental conditions (gaseous phase or liquid phase, presence of molecular oxygen), and supporting material (synthetic polymer structure vs. polysaccharide-based fiber). More specifically this document refers to a method where pre-irradiation of the material is sought, where high radiation doses are applied (˜200 kGy) in pulses of 10 kGy in a few seconds, where a single monomer is utilized e.g. GMA, where the reaction environment is provided by a gas atmosphere, and where the supporting (carrier) material is preferentially polyethylene. The present invention describes a completely different technique where polymerization occurs via simultaneous irradiation in liquid media and in the presence of the polysaccharide support. Application of the conditions described in EP-A-1 514 597 to the simultaneous polymerization and grafting mixture proposed in the present invention would result in the mechanical destruction of the supporting fiber, i.e. no composite material could be obtained. Moreover, application of the dose velocities described in EP-A-1 514 597 to the simultaneous polymerization and grafting mixture proposed by the present invention would result in a non-modified carrier material with concomitant formation of suspended homo-polymer and therefore no-grafting. Therefore, EP-A-1 514 597 cannot result in a composite material with the physical and chemical characteristics which are desired for chromatographic applications.

Summarizing, EP-A-1 514 597 discloses a method where polymer grafting is done by pre-irradiation using an electron beam accelerator. The monomer GMA is grafted onto porous polymers to be accessible to the solution. The resulting material suffers from the blocking of the pores if crude feedstocks are used and also has hydrodynamic restrictions (permeability changes) as a consequence huge changes in the swelling properties of the grafted polymer (Tsuneda, S.; Saito, K.; Sugo, T. and Makuuchi, K. “Protein adsorption characteristics of porous and tentacle anion-exchange membrane prepared by radiation-induced graft polymerization”. Radiat. Phys. Chem., 1995, 46, 239-245).

U.S. Pat. No. 5,059,654 describes the production of a chromatographic composite support by a two step procedure. First, homo-polymerization of GMA is carried out in water at 80° C. to obtain an insoluble, reactive epoxide group containing, synthetic polymer. In a second step, this polymer is covalently attached to a cellulosic fiber via epoxide groups, which are reactive towards the —OH groups in the cellulose (surface) structure. The physical and chemical properties described in U.S. Pat. No. 5,059,654 are not the same as the ones described in the present invention i.e. the method resulted in a macroporous structure attached to the external surface of the supporting fiber. Therefore, the final product is different as judged by swelling, porosity, and proportion of synthetic polymer component within the composite structure. The major drawbacks of the resulting material according to U.S. Pat. No. 5,059,654 are the low swelling capacity and limited dynamic binding capacity for macromolecules, possibly due to the limited amount of functionalized material within the composite structure.

Summarizing, U.S. Pat. No. 5,059,654 describes the production of a chromatographic support by the synthesis of a composite material where a synthetic polymer is covalently bonded to a polysaccharide, where synthetic polymer should has at least one epoxy group capable to coupling to the said polysaccharide given a monolith body which it is generally made in a paper form of different thickness. Synthetic polymer is insoluble and coupling with surface hydroxyl groups of cellulose. The composite material has negligible swelling and shrinking properties (D1 pp 31) and mechanical rigidity and macroporosity are given by the crosslinking reaction between the cellulose and several epoxy groups of the synthetic polymer (D1 pp 30-31). Such material will suffer from the low swelling capacity, thus less ligand accessibility to the protein solution which finally riches low binding capacity. It is also prone to be fouled by crude feedstocks in case of high crosslinking is provided.

### SUMMARY

An aspect of the present invention is to provide an internally grafted homogeneous hydrogel where reactive groups are introducible to perform ligand immobilization by simple chemical reactions. At the same time the chromatography material should exhibit a high swelling factor, resistance (stability) to pH within the range 2.0-11.0, resistance (stability) to temperature up to 121° C., and low operational back-pressures i.e. typically lower than 10 bar. These conditions are not met by the materials obtained according to the preceding documents but by the methodology described in the present invention. In terms of the present invention, a “high swelling factor” denotes an increase in volume by at least 10% of the volume of water-free composite material at 20° C. in distilled water or 10-20 m M aqueous phosphate buffer.

In an embodiment, the present invention provides a method of producing a composite microfiber, and the corresponding microfiber as such, said method comprising the steps of

(i) providing a hydrophilic polysaccharide polymer fiber, the polysaccharide being selected from the group consisting of cellulose, hydroxyethyl cellulose, hydroxypropyl cellulose, methyl cellulose, ethyl cellulose, n-propyl cellulose, isopropyl cellulose, cellulose acetate and combinations of two or more of these substances, and combinations of two or more of these substances,

(ii) gamma radiation induced polymerization of two or more monomers for simultaneous producing and grafting of substituents of formula (I),

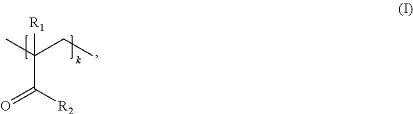

wherein k is 1 or greater,

and wherein each moiety R₁ is independently selected from H and methyl,

and wherein each moiety R₂ is independently selected from —H, —OH, —NH₂, —SH, —OR₃, —NHR₃ and —NR₃R₄, —SR₃,

and wherein each moiety R₃ and R₄ are chemical groups independently selected from C1-C4 alkyl, C1-C4 alkoxy, C1-C4 alkoxy halide and C1-C4 heteroalkyl substituents, and is preferably selected from —CH₃, —CH₂—CH₃, —CH₂—OH, —CH₂—CH₂—OH, —CH₂—CH₂—NH₂, —CH—CH(OH)—CH₂—OH, —CH—CH(OH)—CH₃, glycidyl, anhydride, sulfonic acid and hydroxysuccinimide,

said substituents forming a hydrogel in the presence of water, and

said composite microfiber having a swelling factor of at least 10%, preferably of 10-400%,

wherein said gamma radiation induced polymerization is performed in a liquid medium in the presence of said hydrophilic polysaccharide fiber.

### BRIEF DESCRIPTION OF THE DRAWINGS

The present invention is described in greater detail below on the basis of embodiments and of the drawings in which:

FIG. 1. shows the chemical structure of the composite microfibrous material. Radiation grafting is utilised for the modification of a polysaccharide polymer i.e. cellulose or cellulose derivatives.

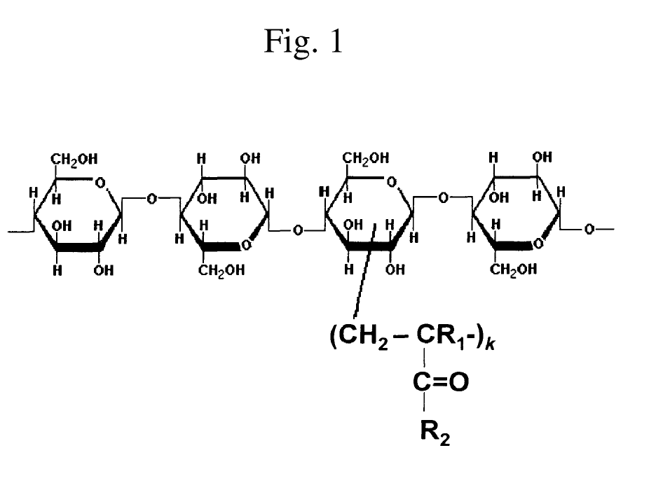

FIG. 2 Shows the internal hydrogel structure within the composite fiber revealed after adsorption of fluorophore-labelled IgG.

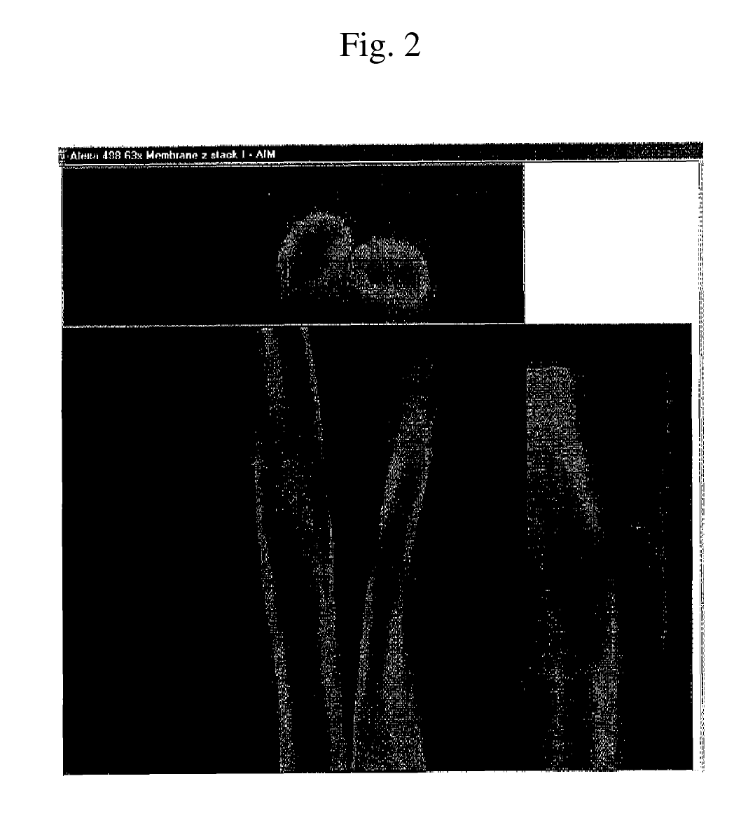

### DETAILED DESCRIPTION

According to the present invention, substituents of formula (I) are simultaneously polymerized and grafted to a hydrophilic polysaccharide polymer fiber in a gamma radiation induced polymerization step. It has surprisingly been found that such simultaneous grafting results in homogeneous grafting of the substituents of formula (I) on the surface and the bulk of the polysaccharide polymer fiber simultaneously. Such homogeneous grafting could not be achieved by pre-irradiation grafting polymerization, a technique otherwise used in the art.

Furthermore, according to the present invention, gamma radiation induced polymerization is performed in a liquid medium, said medium comprising both the hydrophilic polysaccharide polymer fiber and the two or more monomers for simultaneous producing and grafting of substituents of formula (I). It has now been found that polymerization in liquid medium provides advantages over the use of gaseous monomers regarding homogeneity of grafting, swelling rate, pH stability, temperature stability and general resistance against wear and tear.

The method according to the present invention allows to produce a composite microfiber according to the invention, said microfiber

comprising a polysaccharide polymer selected from the group consisting of cellulose, hydroxyethyl cellulose, hydroxypropyl cellulose, methyl cellulose, ethyl cellulose, n-propyl cellulose, isopropyl cellulose, cellulose acetate and combinations of two or more of these substances, and combinations of two or more of these substances,

the polysaccharide polymer further comprising substituents of formula (I)

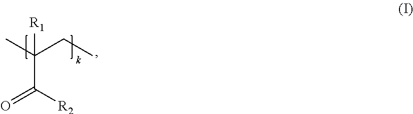

wherein k is 1 or greater,

and wherein each moiety R₁ is independently selected from H and methyl,

and wherein each moiety R₂ is independently selected from —H, —OH, —NH₂, —SH, —OR₃, —NHR₃ and —NR₃R₄, —SR₃,

and wherein each moiety R₃ and R₄ are chemical groups independently selected from C1-C4 alkyl, C1-C4 alkoxy, C1-C4 alkoxy halide and C1-C4 heteroalkyl substituents, and is preferably selected from —CH₃, —CH₂—CH₃, —CH₂—OH, —CH₂—CH₂—OH, —CH₂—CH₂—NH₂, —CH—CH(OH)—CH₂—OH, —CH—CH(OH)—CH, glycidyl, anhydride, sulfonic acid and hydroxysuccinimide,

said substituents forming a hydrogel in the presence of water, and

said composite microfiber having a swelling factor of at least 10%, preferably of 10-400%.

The microfiber of the present invention surprisingly exhibits a high swelling ratio, i.e. a swelling factor of at least 10%, improving the mechanical stability of a chromatography medium. In addition, the microfiber of the present invention is also chemically very stable, and advantageously allows to continually use a chromatography medium comprising or consisting of the microfiber of the present invention for a long time. The material typically resists between 50 and 200 or more complete chromatographic cycles—including equilibration, loading, washing, desorption, and regeneration—with a loss of total dynamic binding capacity lower than 20%. The microfiber of the present invention, when used in or as a chromatography medium, allows diffusion of target molecules into its composite core hydrophilic phase. The hydrophilic core of the microfiber increases the dynamic binding capacity independent of the convective flow properties due to the larger number of binding sites. The novel composite microfibers also circumvent problems associated with beaded media. Typically, a bead media's mechanical strength is coupled to the adsorbing material being used. Having the mechanical and binding properties coupled is a limitation associated with many beaded media. The present invention allows to produce microfibers in hydrogel microfibrous shape with adsorptive properties, obviating the aforementioned drawbacks of beaded media.

The presence of reactive groups onto the composite material allows for the addition of various ligand types which are useful or specific adsorptive process. An appropriate mechanical arrangement of the composite fibers can result in good convective and diffusional mass-flows.

In the method according to the present invention, the monomers for gamma radiation induced polymerization are preferably vinylmonomers, and particularly preferred is a monomer combination comprising glycidyl(meth)acrylate (GMA) and dimethyl acrylamide (DMAA). Generally preferred monomers are selected from the group consisting of 2-hydroxyethyl(meth)acrylate, hydroxyethoxyethyl(meth)acrylate, hydroxydiethoxyethyl(meth)acrylate, methoxyethyl(meth)acrylate, methoxyethoxyethyl(meth)acrylate, methoxydiethoxyethyl(meth)acrylate, polyethyleneglycol(meth)acrylate, methoxy-polyethylene glycol(meth)acrylate, (meth)acrylic acid, sodium(meth)acrylate, glycerol(meth)acrylate, hydroxypropyl(meth)acrylate, and hydroxybutyl(meth)acrylates, 2-acrylamido-2-methyl-1-propanesulfonic acid, 2-(acryloyloxy)ethyltrimethyl-ammonium methyl sulfate, (2-trifluoromethyl)acrylic acid, 3-sulfopropyl acrylate potassium salt, glycidyl(meth)acrylate, morpholine(meth)acrylate(meth)acrylonitrile, (meth)acrylic anhydride, 2-(methacryloxy)ethyl phosphate, N,N′-diethylaminoethyl(meth)acrylate, (3-(methacryloylamino)propyl)trimethylammonium chloride, (3-acrylamidopropyl)trimethylammonium chloride and acrylamide monomers such as acrylamide and substituted acrylamines, such as dimethyl(meth)acrylamide, diethyl(meth)acrylamide, diacetone(meth)acrylamide, aminopropyl(meth)acrylamide and isopropyl(meth)acrylamide. With Copolymers of these monomers, the microfiber of the present invention can be used in or as a particularly mechanically and chemically stable chromatography medium.

The substituent of formula (I), and preferably one of the aforementioned preferred substituents, is preferably crosslinked with a crosslinker selected from the group consisting of functional monomers are polymerised in the presence of cross-linkers like divinylbenzene, ethyleneglycol di(meth)acrylate, 1,4-butanediol di(meth)acrylate, triethyleneglycol di(meth)acrylate, diethyleneglycol di(meth)acrylate, triethyleneglycol di(meth)acrylate and poly(ethylene glycol) di(meth)acrylate, oligo(polyhydroxyalkyl)silyl(meth)acrylate, and ethylene-bis-(meth)acrylamide, methylene-bis-(meth)acrylamide, and piperazine di(meth)acrylamide. These crosslinkers further improve the mechanical stability of the microfiber of the present invention, and thus aid in providing a particularly mechanically stable chromatography medium.

A particularly preferred substituent of formula (I) comprises a glycidyl, oxime, halogen or anhydride functionality, and is further preferably selected from the group consisting of poly(glycidyl methacrylate), poly(acrylamidoxime), poly(methacrylic anhydride) and poly(2-bromoethyl methacrylate) and copolymers thereof.

The liquid medium of step (ii) is preferably a polar liquid medium and most preferably is, is substantially or comprises water. Also preferred are, particularly when mixed with water, one or more of methanol, ethanol, n-propanol, iso-propanol, butanol, ter-butanol, acetonitrile, dimethylsulfoxide, acetone, dimethylformamide, and mixtures thereof.

Further, it is preferred that the composite microfiber of the present invention has a total mass of substituents of formula (I) in the fiber from 5 to 200 wt. % of the polysaccharide weight. Such microfibers have a particularly high swelling index and a good mechanical stability.

The composite microfiber of the present invention preferably has a thickness of 5 to 80 μm in its swollen state. This thickness surprisingly provided microfibers which, when being used in or as chromatography media, result in a good dynamic binding capacity with good of the convective flow properties.

Likewise, it is also preferred that the composite microfiber of the present invention, and particularly the microfiber with a thickness of 5 to 80 μm in its swollen state, has a length of 0.5 to 10 cm. These dimensions further aid in providing a good dynamic binding capacity with good of the convective flow properties.

The composite microfiber of the present invention preferably further comprises one or more modifiers selected from the group consisting of antibodies or F(ab′)₂, Fab, Fv or scFv antibody fragments, (recombinant) protein A, (recombinant) protein G, dyes, chelating groups and imidoacetic acid complexes with Cu²⁺, Ni²⁺, Zn²⁺ or Co²⁺, immobilized on a substituent of formula (I). These modifiers aid particularly well in providing means for adsorbing a target on a chromatographic medium.

According to the invention, there is further provided a chromatographic material, said material comprising, consisting essentially of or consisting of composite microfibers of the invention.

The chromatographic material of the invention is characterized by a swelling factor as defined above of at least 10%, preferably 10 to 400% and most preferentially of 50 to 200% preferably in distilled water at 20° C. With this swelling ratio, particularly good flow properties can be ascertained. For a composite fiber according to the present invention having a substantially circular cross-section, the fiber diameter thus increases 2-3 times upon swelling compared to the fiber in its completely day state.

Another advantage of the chromatography media of the present invention is the simplicity of handling. In general, beads must be packed into a column. The quality of this packing determines the performance of the adsorbing bed. This adds another source of variability to the chromatographic process which must be validated before use. The media according to the invention, however, could operate in several device forms, all which can be properly filled and validated prior to use, eliminating a source of variability during the chromatographic process. In or as chromatography media, the composite microfibers of the present invention are preferably physically arranged in the form of stacked disks, rolls or in parallel or twirled arrangement. With these arrangements, good flow properties can be achieved.

Composite microfibers of the invention can be easily arranged in a parallel configuration that can in preferred embodiments alleviate—in combination with an appropriate surface shielding—deleterious biomass effects on system hydrodynamics and sorption performance. A particularly preferred surface shielding agent is polyethylene glycol. The chromatography media of the present invention allow to achieve higher productivity being amenable of sequestrating the product directly from the fermentation feedstock as it is known from the application of direct sequestration methods and disposable cartridges.

Preferably, the polysaccharide polymer is pre-treated by mercerisation, preferably by alkali hydrophilisation, even more preferably by pre-treating with sodium hydroxide, ammonium hydroxide or potassium hydroxide. Such pre-treatment favorably contributes to the formation of a homogeneous internal hydrogel.

### Production

Natural microfibrous cellulosic material was treated with an aqueous solution of sodium hydroxide (4 N to 6 N) for 2 h to 8 h at 25-60° C. to improve its swelling properties. A carefully washing with tap water is performed to neutrality.

Dry hydrophilic microfibrous material was swelled in a methacrylic/acrylic monomer solution or a mixture of them and exposed to radiation in a cobalt-60 source (dose between 1 and 15 kGy). Degasing the monomer solution by bubbling with nitrogen improve the grafting yields. Radio-induced grafting polymerization is performed according to such experimental procedure.

The resulting microfibrous material was thoroughly washed with a suitable solvent or a sequence of solvents and stored in a 0.1 wt-% aqueous solution of sodium azide to prevent bacterial growth. In order to determine the amount of grafted polymer added to the support, the sample was dried under vacuum at room temperature to a constant mass. The mass gain due to gel incorporation was calculated as a ratio of an add-on mass of the dry gel to the initial mass of the support.

### Ligand Immobilization

As stated above, the microfibrous material can also be selected to comprise reactive functional groups that can be used to attach ligands or other specific binding sites. These functional microfibrous material can be add-on with epoxy, anhydride, reactive halogen, or acid chloride groups that can be used to attach the ligands or other specific binding sites. Examples include poly(glycidyl methacrylate), poly(acrylamidoxime), poly(acrylic anhydride), poly(2-bromoethyl methacrylate) or others. Introduced functional property can take the form of antibodies or fragments of antibodies, or alternatively, chemical mimics such as dyes, chelating groups, or many others. Affinity ligands that can be attached to microfibrous material via reactive groups include antigen and antibody ligands such as monoclonal antibodies, protein A, recombinant protein A, protein G, or recombinant protein G to separate immunoglobulins from different media, dye ligands such as Cibacron blue or Reactive red to separate albumins and various enzymes, metal affinity ligands such as complexes of iminodiacetic acid (IDA) ligand with Cu²⁺, Ni²⁺, Zn²⁺, or Co²⁺ to separate various histidine containing proteins.

### Protein Adsorption/Desorption Experiments

Protein adsorption experiments were carried out with two proteins, namely, bovine serum albumin (BSA) and lysozyme (HEWL). Total human immunoglobulin G was also employed to evaluate dynamic sorption performance.

1) In the case of experiments with a positively charged microfibrous material, a cartridge containing 0.5 gram of material was first washed with distilled water and subsequently with a phosphate buffer solution (pH=7.4). In an adsorption step, a BSA solution, comprising from 0.4 to 0.5 mg BSA per ml of buffer solution, was poured to the cell to give a 5 cm head over the cartridge. This hydrostatic pressure of 5 cm was kept constant by further additions of the BSA solution. In a modification of this method, the cell was pressurized with compressed nitrogen. The flow rate was measured by weighing the amount of permeate as a function of time. Typical values varied between 1 and 5 ml/min.

Permeate samples were collected at 2-5 min intervals and analyzed by UV analysis at 280 nm. Following the adsorption step, the microfibrous cartridge in the cell was washed with about 200 ml of the phosphate buffer solution, and desorption was carried out with a phosphate buffer solution containing 1M NaCl at 5 cm head pressure or under a controlled pressure of compressed nitrogen. The permeate samples were collected at 2-5 min intervals and tested by UV analysis at 280 nm for BSA content.

2) For negatively charged microfibers, a solution of lysozyme in a phosphate buffer solution having a pH of 7.8 and a lysozyme concentration of 0.5 g/L was used in a procedure similar to that described above for BSA and positively charged materials. The flow rate during the protein adsorption was again kept within 1-5 ml/min. Prior to desorption of the protein, the cartridge was washed by passing with 200 ml of the buffer solution. Desorption of the protein was carried out using a phosphate buffer solution (pH=7.8) containing 1M NaCl in the same way as described above for BSA desorption. The lysozyme content in the collected samples was determined by UV spectrophotometry at 280 nm.

3) Protein adsorption tests involve a cartridge with one gram of negatively charged microfibers, which were disposed in a spiral configuration and the lysozyme solution (1 mg/ml) was delivered to the cartridge at controlled flow rate using a syringe-type pump. The eluted fractions were collected and analyzed in the same way as described above. The desorption of the proteins was carried in a similar way as described above, with buffered 1M NaCl delivered to the cartridge by using the pump instead of gravity or compressed nitrogen pressure. Flow rates were between 60 and 600 cm/h and dynamic protein binding capacity between 35 and 44 mg of lysozyme per gram of material in phosphate buffer solution (pH 7.8).

4) Protein adsorption tests involve a cartridge with one gram of negatively charged microfibers, which were disposed as stacked discs and the IgG solution (1 mg/ml) was delivered to the cartridge at controlled flow rate using a syringe-type pump. The eluted fractions were collected and analyzed in the same way as described above. The desorption of the proteins was carried in a similar way as described above, with buffered 1M NaCl delivered to the cartridge by using the pump instead of gravity or compressed nitrogen pressure. Flow rates were between 40 and 350 cm/h and dynamic protein binding capacity between 160 and 205 mg of IgG per gram of material, in acetate buffer solution (pH 5.5). Protein desorption was greater than 80% of the adsorbed IgG.

### Protein Separation Experiment

Protein separation experiments were performed with IDA-Cu²⁺+microfibrous discs stacked onto a XK-16 column and run in an AKTA Explorer chromatographic system (GE Healthcare). A commercial preparation of pectic enzymes was loaded onto the system in a mobile phase consisting in a phosphate-acetate buffer (pH 7.1) containing 0.25 M sodium chloride. Pectin lyase (EC 4.2.2.10) was recovered in the flow-through fraction while polygalacturonase (EC 3.2.1.15) was preferentially eluted with sodium acetate buffer (pH 3) and pectinesterase (EC 3.1.1.11) with EDTA 0.1 M. Flow rate was 350 cm/h and operating pressure below 0.25 Bar.

The present invention is not limited to embodiments described herein; reference should be had to the appended claims.

What is claimed is:

1. A composite microfiber, comprising:
a polysaccharide polymer selected from the group consisting of cellulose, hydroxyethyl cellulose, hydroxypropyl cellulose, methyl cellulose, ethyl cellulose, n-propyl cellulose, isopropyl cellulose, cellulose acetate and combinations of two or more of these substances, and combinations of two or more of these substances,
the polysaccharide polymer further comprising substituents of formula (I) 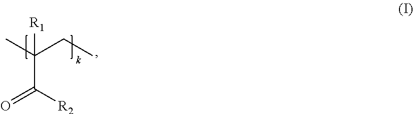
wherein k is 1 or greater,
and wherein each moiety R₁ is independently selected from H and methyl,
and wherein each moiety R₂ is independently selected from —H, —OH, —NH₂, —SH, —OR₃, —NHR₃ and —NR₃R₄, —SR₃,
and wherein each moiety R₃ and R₄ are chemical groups independently selected from C1-C4 alkyl, C1-C4 alkoxy, C1-C4 alkoxy halide and C1-C4 heteroalkyl substituents, such as —CH₃, —CH₂—CH₃, —CH₂—OH, —CH₂—CH₂—OH, —CH₂—CH₂—NH₂, —CH—CH(OH)—CH₂—OH, —CH—CH(OH)—CH₃, glycidyl, anhydride, sulfonic acid and hydroxysuccinimide,
said substituents forming a hydrogel in the presence of water, and
said composite microfiber having a swelling factor of 10-400%.

2. A method of producing a composite microfiber, comprising the steps of:
(i) providing a hydrophilic polysaccharide polymer fiber, the polysaccharide being selected from the group consisting of cellulose, hydroxyethyl cellulose, hydroxypropyl cellulose, methyl cellulose, ethyl cellulose, n-propyl cellulose, isopropyl cellulose, cellulose acetate and combinations of two or more of these substances, and combinations of two or more of these substances,
(ii) gamma radiation induced polymerization of two or more monomers for simultaneous producing and grafting of substituents of formula (I), 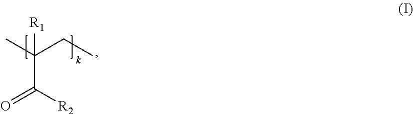
wherein k is 1 or greater,
and wherein each moiety R₁ is independently selected from H and methyl,
and wherein each moiety R₂ is independently selected from —H, —OH, —NH₂, —SH, —OR₃, —NHR₃ and —NR₃R₄, —SR₃,
and wherein each moiety R₃ and R₄ are chemical groups independently selected from C1-C4 alkyl, C1-C4 alkoxy, C1-C4 alkoxy halide and C1-C4 heteroalkyl substituents, such as —CH₃, —CH₂—CH₃, —CH₂—OH, —CH₂—CH₂—OH, —CH₂—CH₂—NH₂, —CH—CH(OH)—CH₂—OH, —CH—CH(OH)—CH₃, glycidyl, anhydride, sulfonic acid and hydroxysuccinimide,
said substituents forming a hydrogel in the presence of water, and
said composite microfiber having a swelling factor of 10-400%,
wherein said gamma radiation induced polymerization is performed in a liquid medium in the presence of said hydrophilic polysaccharide fiber.

3. The method as recited in claim 2, wherein:
a) the monomers for gamma radiation induced polymerization are vinyl monomers, such as glycidyl methacrylate (GMA) and dimethyl acrylamide (DMAA) and/or
b) the liquid medium is a polar liquid medium and such as water and optionally one or more of methanol, ethanol, n-propanol, iso-propanol, butanol, ter-butanol, acetonitrile, dimethylsulfoxide, acetone, dimethylformamide, and mixtures thereof.

4. The method as recited in claim 2, wherein the gamma radiation induced polymerization is performed in the absence of a polymerization initiator substance, such as in the absence of peroxides and/or azo compounds.

5. The method as recited in claim 2, wherein the gamma radiation induced polymerization is performed with
a) a radiation dose of 5-15 kGy, and/or
b) a dose velocity of 0.1-1 kGy/h.

6. The method as recited in claim 2, wherein the hydrophilic polysaccharide fiber of step (i) is pre-treated by alkali hydrophilization, such as by pre-treating with sodium hydroxide, ammonium hydroxide or potassium hydroxide.

7. The method as recited in claim 2, wherein step (ii) is performed in such way that the total mass of substituents of formula (I) is 5-200 wt % based on the total mass of hydrophilic polysaccharide fiber provided in step (i).

8. A composite microfiber, obtainable or obtained by a method as recited in claim 3.

9. The composite microfiber as recited in claim 8, wherein the total mass of substituents of formula (I) is 5-200 wt % based on the total mass of hydrophilic polysaccharide.

10. The composite microfiber as recited in claim 8, wherein each substituent of formula (I) is selected from the group consisting of (poly)acrylamides, (poly)methacrylamides, (poly)acrylates, (poly)methacrylates, and polymers producible with one or more monomers selected from the group consisting of 2-hydroxyethyl(meth)acrylate, hydroxyethoxyethyl(meth)acrylate, hydroxydiethoxyethyl(meth)acrylate, methoxyethyl(meth)acrylate, methoxyethoxyethyl(meth)acrylate, methoxydiethoxyethyl(meth)acrylate, polyethyleneglycol(meth)acrylate, methoxy-polyethylene glycol(meth)acrylate, (meth)acrylic acid, sodium(meth)acrylate, glycerol(meth)acrylate, hydroxypropyl(meth)acrylate, and hydroxybutyl(meth)acrylates, 2-acrylamido-2-methyl-1-propanesulfonic acid, 2-(acryloyloxy)ethyltrimethyl-ammonium methyl sulfate, (2-trifluoromethyl)acrylic acid, 3-sulfopropyl acrylate potassium salt, glycidyl(meth)acrylate, morpholine(meth)acrylate(meth)acrylonitrile, anhydride(meth)acrylic, 2-(methacryloxy)ethyl phosphate, N,N′-diethylaminoethyl(meth)acrylate, (3-(methacryloylamino)propyl)trimethylammonium chloride, (3-acrylamidopropyl)trimethylammonium chloride and acrylamide monomers such as acrylamide and substituted acrylamines, such as dimethyl(meth)acrylamide, diethyl(meth)acrylamide, diacetone(meth)acrylamide, aminopropyl(meth)acrylamide, isopropyl(meth)acrylamide, or copolymers of these substituents.

11. The composite microfiber as recited in claim 8, wherein the substituent of formula (I) is crosslinked with a crosslinker monomer selected from the group consisting of divinylbenzene, ethyleneglycol di(meth)acrylate, 1,4-butanediol di(meth)acrylate, triethyleneglycol di(meth)acrylate, diethyleneglycol di(meth)acrylate, triethyleneglycol di(meth)acrylate and poly(ethylene glycol) di(meth)acrylate, oligo(polyhydroxyalkyl)silyl(meth)acrylate, and ethylene-bis-(meth)acrylamide, methylene-bis-(meth)acrylamide, and piperazine di(meth)acrylamide.

12. The composite microfiber as recited in claim 8, wherein a substituent of formula (I) comprises a glycidyl, oxime, halogen or anhydride functionality.

13. The composite microfiber as recited in claim 1, having:
(a) a thickness of 5-80 μm in its swollen state and/or
(b) a length of 0.5-10 cm.

14. The composite microfiber as recited in claim 8, further comprising immobilized thereon one or more modifiers selected from the group consisting of antibodies or F(ab′)2, Fab, Fv or scFv antibody fragments, (recombinant) protein A, (recombinant) protein G, dyes, chelating groups and imidoacetic acid complexes with Cu²⁺, Ni²⁺, Zn²⁺ or Co²⁺.

15. A chromatographic material comprising a composite microfiber as recited in claim 8.

16. The chromatographic material as recited in claim 15, further comprising a swelling ratio of 10 to 400% in distilled water at 20° C.

17. The chromatographic material as recited in claim 15, wherein the composite microfibers are arranged in the form of stacked disks, rolls, or in parallel or twirled arrangement.

18. A chromatography device comprising a chromatographic adsorption section, said section comprising the chromatographic material as recited in claim 15.

19. A method of using a composite microfiber as recited in claim 8 an as adsorptive material in chromatography, the method comprising:
(a) providing a composite microfiber as recited in claim 8; and
(b) using the composite microfiber as an adsorptive material in chromatography.
